(19) United States
(12) Patent Application Publication
(10) Pub. No.: US 2001/0031631 A1
(43) Pub. Date: Oct. 18, 2001

(54) Secure area communication arrester

(76) Inventor: Robert L. Pitts, Dallas, TX (US)

Correspondence Address: Texas Instruments Incorporated, Mark E. Courtney, P.O. Box 655474, MS 3999, Dallas, TX, 75265, US

(21) Appl. No.: 09/757,105

(22) Filed: Jan. 8, 2001

Related U.S. Application Data
(60) Provisional application No. 60/175,661, filed on Jan. 12, 2000.

(51) Int. Cl. H04M 3/16; H04Q 7/20

(52) U.S. Cl. 455/411; 455/426; 455/432; 455/414; 455/456; 455/528; 455/561

(57) ABSTRACT

A system whereby a short-range base station (pico-station) controls mobile communications within a limited area, such as a theater or airport, where the use of mobile phones or other communications devices is annoying or hazardous. The pico-station determines if mobile communications devices under its control are equipped to operate in a silent-communications mode. Within the limited area, calls to and from the communications devices are either blocked or restricted to silent operation, depending on the capabilities of the communications device.

### BACKGROUND AND SUMMARY OF THE INVENTION

The present invention relates to personal communications devices, such as portable telephones and pagers.

Background: Growth of Personal Communications

In recent years, the use of pagers and mobile telephones has skyrocketed, allowing consumers to be accessible by phone twenty-four hours a day. As with many developing technologies, new capabilities bring a new set of problems. In the case of personal communications, some of the problems created are in two areas: safety and courtesy.

On the safety side, it is possible for transmissions from a mobile telephone at close range to cause interference with more critical communications. A prime example is the communications between a pilot and the control tower: travellers are familiar with the request that portable electronics be turned off during critical times such as take-off and landing. Another example is in hospitals, where unregulated communications can disrupt the use of sensitive equipment.

Even when safety is not a concern, the courtesy factor of mobile communications is still in its infancy and the use of personal communications devices in public can be a major nuisance. For example, patrons who have paid to see a show or listen to music can find it very annoying to have a performance interrupted by the sound of a telephone ringing and even more annoying to have the recipient answer the call at his seat. Likewise, any large gathering of people, such as for jury duty, will often be disturbed by a large number of phone calls or pages for someone in the group.

Many pagers and mobile telephones today are equipped to selectively vibrate or flash the display, rather than ringing, as a silent means of alerting the user to an incoming call or message. This has helped the problem of noisy devices, but offers no solution for the times when a user forgets (or chooses not) to switch the device to a silent mode. Likewise, it does nothing to help when outgoing calls should be stopped, such as in planes or theaters.

Of course, there are people who really DO need to be available at all times, such as critical care physicians. Others, whose availability to the public is not as urgent, may nevertheless feel the need to be reached by phone at all times, e.g., a person with young children or aging parents, or an executive who must respond to business problems quickly.

Background: Cellular Paralyzer

In response to these and other concerns, at least one company in Israel manufactures radio frequency (RF) transmitters, which jam and “paralyze” any communications devices within its range, blocking both incoming and outgoing communications instantly.

A Japanese patent, JP11017600A, detects the radio waves from a mobile device which is powered on. A speaker can be used to audibly remind the user to turn off the device and/or the mobile device is instructed to turn itself off.

While these solutions keep phones from ringing annoyingly, they do not allow for the legitimate need for receiving messages, and many people will not find this to be a viable solution.

In another Japanese patent, JP10276473A, the mobile device has the ability to use the information sent by several base stations to determine its own location. When this location corresponds to a position which is known to be a transmission inhibition area, the device inhibits the transmission of a signal from the device.

Background: Mobile Communications

Although there are many systems for mobile communications, one common architecture is the cellular telephone system. Cellular telephone systems consist of mobile hand-held units and stationary transceiver units, or “base station.” When a mobile unit is turned on, it establishes communication with the strongest base which will support it and the base unit provides a connection into the telephone system. As the user moves, the mobile unit is switched to communicate with whichever available base is strongest, so that the user is constantly in connection with some base unit. Each base unit's area of communication is a “cell.”

Cellular telephone communications take place via radio frequency (RF) signals. Due to regulation, only a limited range of frequencies are available for cellular telephone service providers to use. This limits the capacity or number of users a cellular telephone system can handle at any one time. Cellular telephone service providers constantly seek to increase the capacity of their systems without decreasing quality of communication for individual users. There are several ways to allow multiple users access to a limited bandwidth. Two ways that are commonly implemented today in the U.S. are Time Division Multiple Access (TDMA) and Code Division Multiple Access (CDMA), both of which are digital technologies.

Time Division Multiple Access increases capacity by dividing the system bandwidth into frequency channels using frequency division multiple access (FDMA, an earlier system), and further dividing each channel into discrete time slots. Each user transmits within a given time slot on a given channel. By reading the data from a given time slot, an individual mobile unit's data can be extracted from the system bandwidth. This method of data transfer has a finite capacity—once all the time slots in all the available channels are in use, the system cannot accommodate further users.

Code Division Multiple Access offers a different approach to communication. Instead of each user transmitting only within a given frequency channel, all users transmit simultaneously over the entire bandwidth of the system. Spreading codes differentiate one signal from another. Each signal has its own spreading code, which is (theoretically) orthogonal to all other spreading codes used in the system. The spreading codes modulate each signal differently, and a given signal is recovered from the general signal by applying the proper demodulation (“despreading”) code. Signals that do not correspond to the current despreading code are filtered. With this system, a new user can always be added to the current users, but the quality of the reception will degrade as the numbers increase, thereby limiting the effective number of users.

No matter what system is being used, it is necessary to prevent the signal from one transmitter from interfering with a signal from another transmitter operating on the same channel. For this reason, each system will allocate specific channels for use by each transmitter, with adjacent transmitters not using the same channels. In this manner, there is enough separation between transmitters operating on the same channel to minimize any interference. Various systems have different algorithms regarding how often a channel is reused, but all must be cognizant of this problem.

There are many systems and standards for these systems in use, both across the United States and around the world, but some general method of handling calls are true across the different systems. For one, whether the system uses CDMA or TDMA, different “channels” are defined for various purposes (in CDMA, orthogonal spreading codes define the channels). In general, a communications system can have, in addition to the traffic channels which carry the user-to-user communications, one or more control channels which it uses to handle overhead functions between the base and mobile user. For instance, when a mobile unit is turned on, it first initializes itself, then scans control channels, choosing the best one (generally based on the strength of the signal). It then goes through a registration process with the base station with which it establishes communications, informing the base station of its identity and letting the system know within what cell it is operating. The mobile telephone then monitors the data on the control channel, checking for its own ID to be paged or for global orders which may be sent. Likewise, when a mobile phone user dials a call, the mobile unit uses one of the overhead channels to request a traffic channel for the conversation; when a call comes in for a user, the base unit pages the mobile unit to inform it of the call on another “overhead” channel. Transferring the mobile unit from one base station to another will also be done on the overhead channels.

Thus, no matter what the system or the type of signal it uses, the mobile unit will always monitor at least one control channel to look for incoming calls or messages.

Further information on the various systems available can be found in WIRELESS AND PERSONAL COMMUNICATIONS SYSTEMS, Vijay K. Garg and Joseph E. Wilkes (1996), which is hereby incorporated by reference.

Local Area Audible Communication Arrestor

In the disclosed system a base station having a very limited range (called hereafter a pico-station) is placed, for example, in the ceiling of a music hall or court room. For mobile users within its limited range, the pico-station is the base station which handles all incoming and outgoing communications. Using the control channel normally used by the system, the pico-station can request information from a mobile telephone (or other communications device) about whether it is capable of handling silent communications.

Mobile phones which are equipped with the disclosed system will respond positively to the query from the pico-station. These phones will be instructed not to ring, but can use vibrators, a flashing display, or other silent means of alerting the user of an incoming call. The phone can be allowed to receive incoming calls (listen only), but only silent responses are possible, such as using the keypad. Since use of a phone keypad for sending messages can be a laborious process, one options if to allow a keypad function to send one of several standard messages to the caller, or even a personal pre-recorded message, such as:

1) Callee is in a secure area, call back later

2) Callee is in a secure area, will call you back later

3) Please hold while callee exits secure area

4) Callee can listen only.

Older phones which are not equipped with the disclosed system will not be able to respond to the query from the base station. For them, no outgoing or incoming calls will be allowed; incoming calls can be forwarded to a message center, if available and/or a call missed message can be displayed by the phone. The user must then exit the protected area to accept or return a call.

The disclosed innovations, in various embodiments, provide one or more of at least the following advantages:

disables audible functions (e.g., ringer, microphone);

call originator can automatically or manually receive a message that the callee is in a communications secure area;

devices are automatically switched without the need for user intervention;

users to whom communications are crucial can use the disclosed system to maintain contact;

annoying disturbances are reduced;

the user cannot override;

uses existing hardware already in communications devices (display, microcontroller, etc.).

### BRIEF DESCRIPTION OF THE DRAWINGS

The disclosed inventions will be described with reference to the accompanying drawings, which show important sample embodiments of the invention and which are incorporated in the specification hereof by reference, wherein:

FIGS. 1A and 1B show flowcharts of the decision process for incoming and outgoing calls within the restricted area.

FIG. 2 shows a block diagram of a mobile telephone which can use the disclosed communications arrestor.

FIG. 3 shows a pager which can use the disclosed communications arrestor.

FIG. 4 shows a building in which the disclosed communications arrestor is in use.

### DETAILED DESCRIPTION OF THE PREFERRED EMBODIMENTS

The numerous innovative teachings of the present application will be described with particular reference to the presently preferred embodiment. However, it should be understood that this class of embodiments provides only a few examples of the many advantageous uses of the innovative teachings herein. In general, statements made in the specification of the present application do not necessarily delimit any of the various claimed inventions. Moreover, some statements may apply to some inventive features but not to others.

In the disclosed system, an establishment, such as a hospital or theater, which wished to prevent unwanted communications within an area would be able to install a low-power base station (pico-station) which would control mobile communications within a specific range. This would allow the operators of the base station to set limits on audible communications within its immediate area.

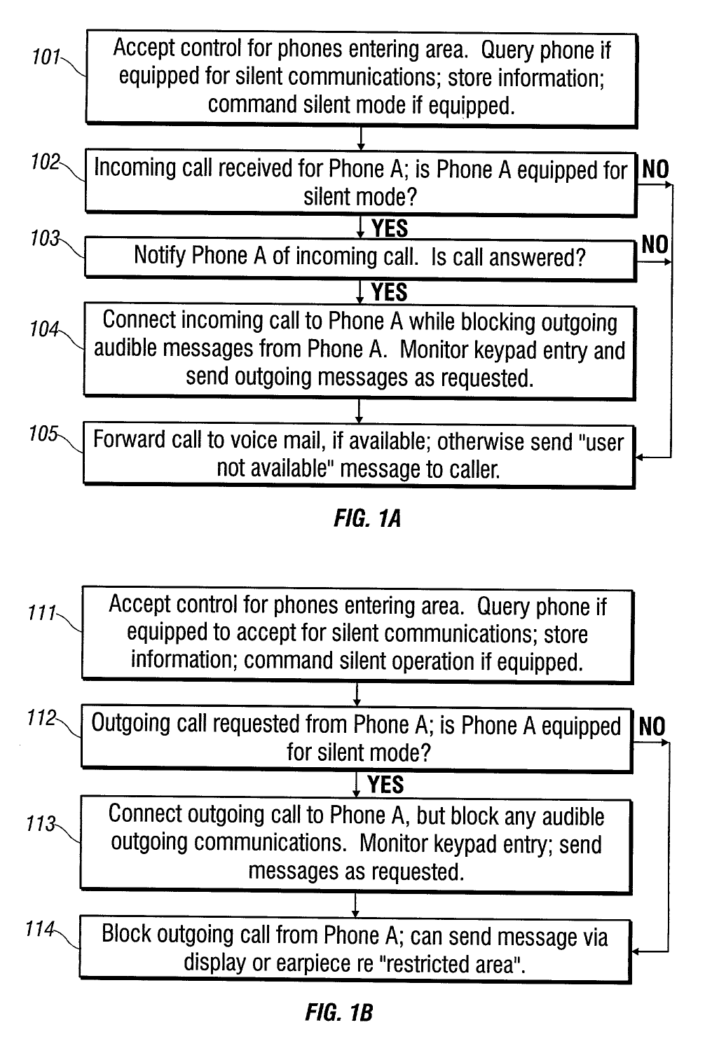

FIG. 1A shows a simple flowchart of the logic used by the pico-station for incoming calls. In step 101, the pico station determines that a mobile phone is within its given area and uses normal protocol to establish its control of the mobile phone. As part of the normal routine of establishing control, the pico-station queries the phone whether it is equipped with the disclosed system for silent communications. A telephone which is so equipped will give a positive response; older telephones, which are not so equipped will not recognize the query and will not respond. The answer, or lack of it, is noted in the information kept for each active phone in the system, while phones which are equipped for silent operation are commanded to go into silent mode.

In step 102, an incoming call is received for a particular phone, in this case Phone A. The stored information is checked to see if this phone is equipped to operate in a silent mode. If the answer is “no”, the flow goes to step 105, where the call will NOT be forwarded to the user, but will be handled as if the user did not answer the phone. The call can be forwarded to voice mail, if available, or a message can be sent to the caller that the user is unavailable or in a restricted area. Optionally, notification of the missed call can be sent to the older phone, or notification can wait until they leave the restricted area.

If the phone is equipped to operate in silent mode, the pico-station notifies the phone of the incoming call (step 103). The phone, which has been commanded to operate in silent mode, will notify the user by vibration, a blinking display, or other silent means. If the user does not answer the call, the call is handled (step 105), as it normally would be, by forwarding to voice mail or sending a message that the user is not available.

If the call is answered (step 104), incoming audible messages will be routed to the earpiece, as usual, but outgoing audible messages will not be transmitted. Keypad entries will be transmitted to the pico-station, which can send outgoing messages as requested by keypad.

FIG. 1B is a flowchart of the control of outgoing calls. As in FIG. 1A, the pico-station accepts control of the mobile phone in its area (step 111), establishing whether that phone is equipped for silent mode, and communicates the need for silent mode to the phone, where appropriate.

The user of Phone A then dials an outgoing call. As soon as the pico-station detects the request for a phone line, it checks to see whether the phone is equipped for silent mode operation. If not, the call will not be completed (step 114). Optionally, a message can be displayed on the phone or played over the earpiece to remind the user that they are in a restricted area.

If the phone is equipped for silent operation, the call is connected (step 113), but audible messages from the user are not transmitted. Instead, the user must utilize the keypad, stored messages retrieved in response to keypad entries, or other silent means of communications.

In both the flowcharts, the user is unable to override the silent function, since this is controlled by the base station which is handling its communications with the rest of the world.

If the user is on a phone call when they walk into a broadcast area controlled by the pico-station, it will be necessary to terminate at least the outgoing verbal part of the conversation. To avoid a person unwittingly entering a limited communications zone while on the phone, the system can optionally be programmed to provide an audible signal through the earpiece (or another type of signal) to alert the user that they are entering a restricted communications area. A signal can also be sent to the person with whom they are talking, alerting them to the situation. The user can then be given a short time period to chose to leave the area or to have his verbal conversation terminated.

Other features can be added to the system. For instance, when a call is put through to a user equipped with silent mode, users can choose to have their restricted status announced to the caller as soon as the call is answered. In this manner, the caller will know not to expect the user to reply vocally.

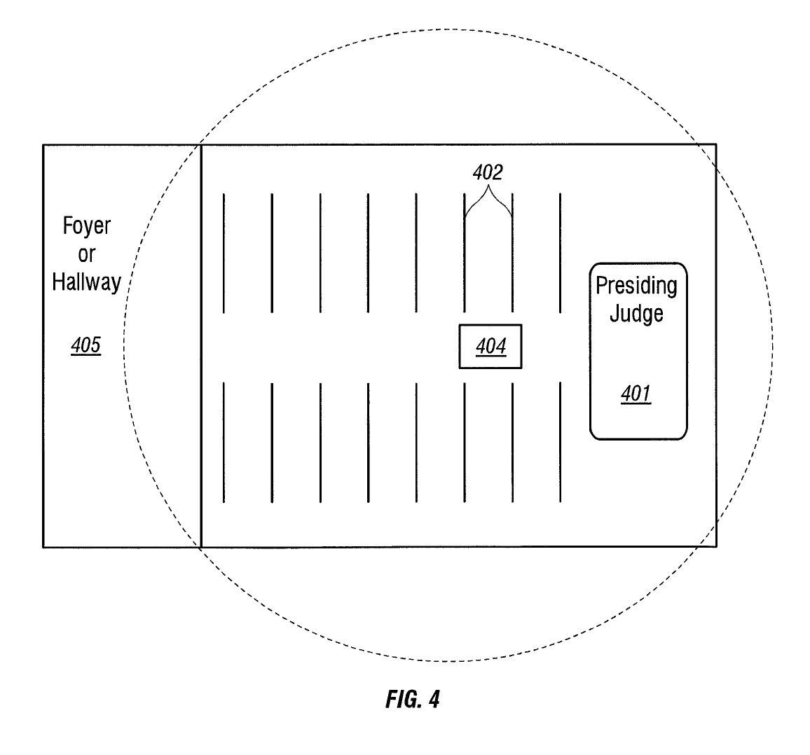

FIG. 4 shows a room in which a low-power pico-station 404 is operating. For the purpose of illustration, the room is assumed to be a large jury selection room, although it could be any location in which ringing phones or two-way communications are either offensive or dangerous. In this room, a judge's bench 401 is adjacent seating 402 for potential jurors. Transmitter 404 is located in the ceiling of the room, and its effective range is shown by the dotted lines. Users of mobile communication devices are unable to make verbal calls within the dotted lines. However, once the user moves to the area outside the dotted lines, such as the foyer 405, the low-power pico-station will no longer be the controlling station, and calls are again possible. Typically, a system which transmits on 100 mw of power can cover an area of 5,000 to 50,000 square feet, while adjustments can be made in the signal strength to allow for differences in desired coverage.

Because of the numerous systems available, both analog and digital, it will be necessary that the pico-station be designed to output a signal on each control channel that is used in its given area. Thus, it is necessary to know not only the channels used in that locale, but also the format in which they are transmitted. In the U.S., this can mean that it will be necessary to transmit on the appropriate digital control channels in both TDMA and CDMA format, as well as on analog control channels and in the appropriate analog format(s). Of course, if at any time a national or global standard emerges, this would simplify the signalling and allow only one signal to be sent in the standardized format.

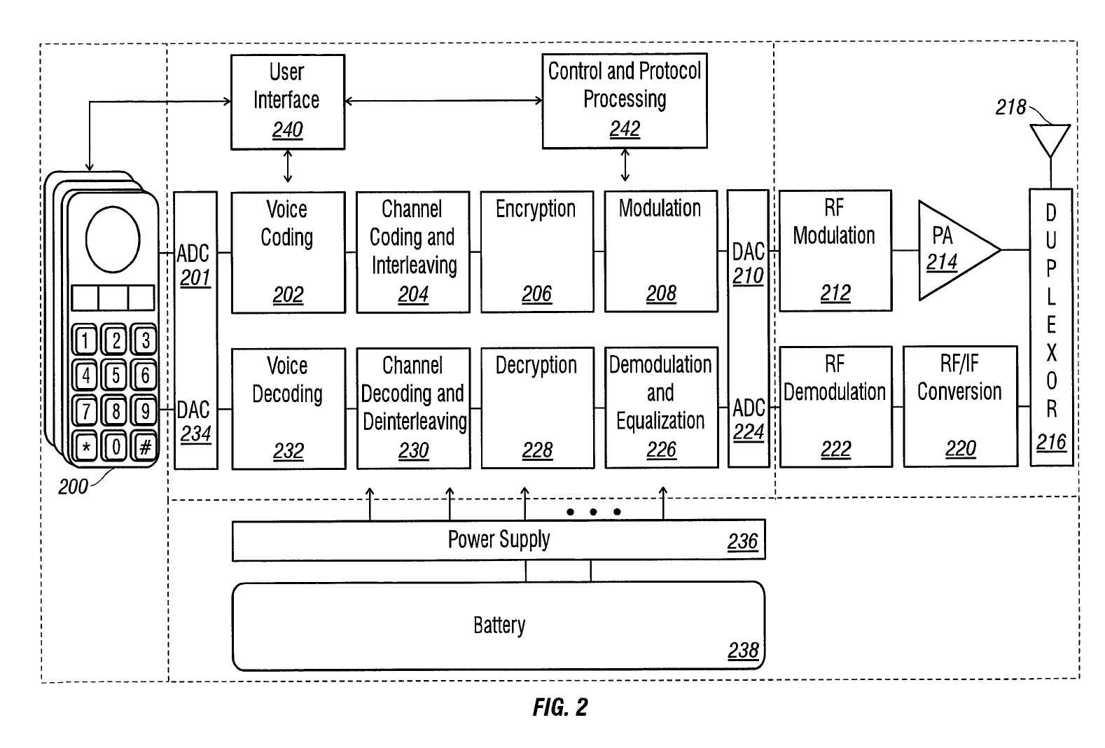

FIG. 2 shows a block diagram of a mobile telephone 200 which can contain the disclosed logic to handle silent mode operation. In operation, the user speaks into the receiver where analog-to-digital circuitry 201 digitizes the analog voice signal and presents it to the voice encoding stage 202. The output of the voice encoding stage 202 is processed by a channel coding and interleaving stage 204, and then by an encryption stage 206 which scrambles the information for transmission. Subsequent to encryption, the signal is modulated (stage 208) and passed to the digital-to-analog circuitry 210 in preparation for high-frequency RF modulation 212. The resulting RF signal is amplified (stage 214) and passed through the duplexor circuitry 216 to the transmitting antenna 218. In the receive mode, an RF signal is received through antenna 218 and duplexor circuitry 216. RF/IF conversion circuitry 220 processes the signal and presents it to the RF demodulator 222, from which a modulated baseband signal is sent to the analog-to-digital circuitry 224. The resulting digital signal is passed through the demodulation and equalization stage 226 into the decryption stage 228. The channel decoding and deinterleaving stage 230 receives the signal and passes it to voice decoding stage 232. At the output, the signal is converted to analog (by DAC 234) and sent to the telephone audio speaker. Battery 238 and power supply 236 provide power to the circuitry. The user interface 240 is managed by a control and protocol processing stage 242, which can be implemented, for example, as a low-power microcontroller. Stage 242 also handles the interface to the base station, monitoring for incoming calls, requesting a channel for outgoing calls, and handling other overhead tasks. It is this stage that would typically handle the additional overhead of detecting the request for silent-mode and signalling the phone to operate in this mode. A digital signal processor chip, controlled by stage 242, preferably performs frame synchronization (and other functions) in stage 228.

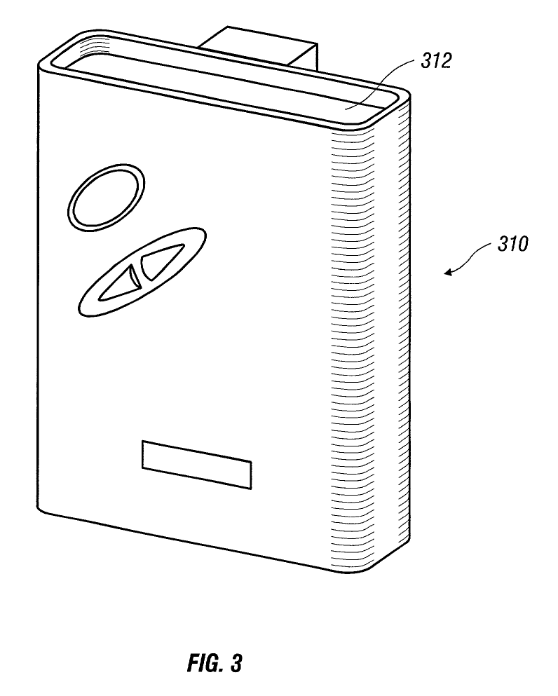

FIG. 3 shows a pager 310, including a display 312, which can use the disclosed logic. Of course, in a pager, there is no two-way communications to be blocked, but any ringers or buzzers can be disabled in favor of silent notification when under control of the pico-station.

According to a disclosed class of innovative embodiments, there is provided: A personal communications device which allows audible signals, comprising: a receiver connected to receive control commands from a transmitter; circuitry connected to said receiver to decode said control commands and check for a given code and connected to control at least one option in said communications device in response to receipt of said given code.

According to another disclosed class of innovative embodiments, there is provided: A communications system, comprising: a plurality of base stations, each capable of radio frequency communications with a plurality of personal communications devices; wherein ones of said plurality of personal communication devices each contain an ability to detect a predetermined command and in response to receipt of said predetermined command, to set the respective personal communication device to a mode in which no audible signals are allowed; wherein ones of said plurality of personal communications devices are not allowed to make or receive calls when under control of a first one of said base stations, based on the lack of said ability.

According to another disclosed class of innovative embodiments, there is provided: A wireless communications system, comprising a short-range base station which controls wireless mobile communications within a limited range, wherein wireless communication devices within said reception area are either restricted to silent communications or, if not equipped for silent communications, blocked from all communications.

According to another disclosed class of innovative embodiments, there is provided: A method of operating a wireless communications device, comprising the steps of: (a.) checking for a known signal; (b.) when said known signal is being received, automatically configuring said communications device to a silent-communications-only mode; (c.) when said known signal is not being received, allowing a user to select the communications mode desired.

According to another disclosed class of innovative embodiments, there is provided: A method of operating a wireless communications system, comprising the step of controlling wireless communications within a known area, wherein wireless communication devices within said known area are either blocked or restricted to silent communications, depending on the capabilities of said communications devices.

Modifications and Variations

As will be recognized by those skilled in the art, the innovative concepts described in the present application can be modified and varied over a tremendous range of applications, and accordingly the scope of patented subject matter is not limited by any of the specific exemplary teachings given, but is only defined by the issued claims.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC section 112 unless the exact words “means for” are followed by a participle.

What is claimed is:

1. A personal communications device which allows audible signals, comprising:
a receiver connected to receive control commands from a transmitter;
circuitry connected to said receiver to decode said control commands and check for a given code and connected to control at least one option in said communications device in response to receipt of said given code.

2. The communications device of claim 1, wherein said one option which is deactivated is outgoing audible communications.

3. The communications device of claim 1, wherein said one option which is deactivated is audible signals from said communications device.

4. The communications device of claim 1, wherein when said circuitry no longer detects said given code, said option is re-enabled.

5. The communications device of claim 1, wherein said communications device is a telephone or pager

6. A communications system, comprising:
a plurality of base stations, each capable of radio frequency communications with a plurality of personal communications devices;
wherein ones of said plurality of personal communication devices each contain an ability to detect a predetermined command and in response to receipt of said predetermined command, to set the respective personal communication device to a mode in which no audible signals are allowed;
wherein ones of said plurality of personal communications devices are not allowed to make or receive calls when under control of a first one of said base stations, based on the lack of said ability.

7. The communications system of claim 6, wherein said first one of said base stations is a low-power base station.

8. A wireless communications system, comprising a short-range base station which controls wireless mobile communications within a limited range, wherein wireless communication devices within said limited range are either restricted to silent communications or, if not equipped for silent communications, blocked from all communications.

9. The wireless communications system of claim 8, wherein said wireless communications system is installed in a location chosen from the group comprising an airplane, a hospital, a theater, a restaurant, a court of law, an assembly hall, a board room, and a jury selection room.

10. A method of operating a wireless communications device, comprising the steps of:
(a.) checking for a known signal;
(b.) when said known signal is being received, automatically configuring said communications device to a silent-communications-only mode;
(c.) when said known signal is not being received, allowing a user to select the communications mode desired.

11. The method of claim 10, wherein said silent-communications-only mode disables outgoing verbal communications from said communications device.

12. The method of claim 10, wherein said silent-communications-only mode disables ringers and other noise-making devices on said communications device.

13. The method of claim 10, wherein said silent-communications-only mode allows keypad entry by the user which triggers transmission of pre-recorded messages.

14. A method of operating a wireless communications system, comprising the step of controlling wireless communications within a known area, wherein wireless communication devices within said known area are either blocked or restricted to silent communications, depending on the capabilities of said communications devices.

15. The method of claim 14, wherein said step of controlling wireless communications is done in more than one format on more than one channel.
